(19) United States
(12) Patent Application Publication
(10) Pub. No.: US 2002/0096797 A1
(43) Pub. Date: Jul. 25, 2002

(54) Method for forming an article comprising closed-cell microfoam from thermoplastic

(75) Inventors: Jan Uilke Stoffelsma, Hardenberg (NL); Johan Gons, Dedemsvaart (NL); Hans Overeijnder, Hardenberg (NL)

Correspondence Address: BLANK ROME COMISKY & MCCAULEY, LLP, 900 17TH STREET, N.W., SUITE 1000, WASHINGTON, DC, 20006, US

(73) Assignee: WAVIN B.V, CW Zwolle (NL)

(21) Appl. No.: 10/034,254

(22) Filed: Jan. 3, 2002

Related U.S. Application Data
(63) Continuation of application No. PCT/NL00/00491, filed on Jul. 12, 2000.
(63) Continuation of application No. 09/354,714, filed on Jul. 16, 1999, now abandoned.

(30) Foreign Application Priority Data
Jul. 16, 1999 (NL) 1012621

(51) Int. Cl. B29C 44/02; B29C 44/20

(52) U.S. Cl. 264/45.9; 264/51; 264/54

(57) ABSTRACT

The invention relates to a method for forming an article comprising closed-cell microfoam from thermoplastic, wherein at least one molten thermoplastic comprising a foaming agent is subjected under pressure to a forming operation and, after the pressure has been at least partially released is cooled, wherein the amount of foaming agent is substantially identical to the amount corresponding to that quantity of gas released by the foaming agent which is comprised by a close-packed structure of the foam cells having a specific foam-cell diameter, substantially uniform throughout the foam, at the pressure prevailing during cool-down.

The use of a nucleating agent is beneficial, and in the method according to the invention the concentration thereof proves to be a determining factor for the mean foam-cell diameter.

### CROSS-REFERENCE TO RELATED APPLICATION

This is a continuation of PCT/NL00/00491 filed Jul. 12, 2000, which PCT application claims priority of Dutch patent application NL 1012621 filed Jul.16, 1999 and U.S. Pat. application Ser. No. 09/354,714 filed Jul. 16, 1999.

### FIELD OF THE INVENTION

The invention relates to a method for forming an article comprising closed-cell microfoam from thermoplastic in which at least one molten thermoplastic comprising a foaming agent is subjected under pressure to a forming operation and, after the pressure has been at least partially released, is cooled.

### BACKGROUND OF THE INVENTION

A method of this type is disclosed by WO-98/08667.

This publication describes an extrusion method for forming articles from thermoplastic, which involves mixing a stream of molten thermoplastic being mixed under pressure with a fluid which at ambient conditions is a gas, whereupon the mixture of molten thermoplastic and fluid is subjected to so-called nucleation to form sites in the mixture which promote the formation of gas bubbles during and after forming and pressure reduction. The fluid used is a material which at ambient conditions is a gas, examples including nitrogen, carbon dioxide, air and the like.

The amount of fluid used in the said publication is fairly large and, for example, is at least 2 wt %, based on the weight of the mixture as a whole. It is stated that a uniform foam containing microcells of diameters of less than 50 micrometres is obtained, the diameter likewise being uniform throughout the foam.

The applicant has carried out extensive research and has found that the said method does indeed make it possible to produce a foam having small foam cells, but that the uniformity of the foam-cell diameter and the reproducibility of the method are unsatisfactory, whilst in certain cases the mechanical strength of the formed article is likewise unsatisfactory.

### SUMMARY OF THE INVENTION

It has now been found, surprisingly, that excellent uniformity of the foam-cell diameter can be obtained, as well as very good, reproducible mechanical strength properties and very good product reproducibility if the amount of foaming agent is substantially identical to the amount corresponding to that quantity of gas incorporated in the foaming agent which is comprised by a close-packed structure of the foam cells having a specific foam-cell diameter, substantially uniform throughout the foam.

With close-packing in the present invention a packing is considered which is built from a regular stacking of cubes whereafter the cubes have been replaced by spheres whereby the centre of each sphere coincides with the centre of the corresponding cube.

For uniform spheres in in the close packing as defined above the total volume of the cells approximate 50%.

In other words, it has been found that various problems encountered in the prior art are related to the use of an excessive amount of foaming agent and that the use of an amount of foaming agent which substantially corresponds to an amount of gas accommodated in a close-packed structure of foam cells is highly suitable for forming a highly uniform foam and that considerably larger amounts will lead to unacceptable non-uniformity of the foam-cell diameter.

It will obviously be possible, in the method according to the invention, to permit an amount of foaming agent somewhat larger than the theoretical amount corresponding to a close-packed structure, for example to compensate for any slight leakage of the equipment. Care should however be taken to ensure that the amount of gas present during foaming is by and large just sufficient to form a close-packed structure of foam cells of a specific, relatively small diameter.

The prior art as mentioned above provides a detailed description of an extrusion process; the abovementioned preamble in general terms comprises the forming process, wherein a mixture of thermoplastic and a foaming agent is subjected to a forming operation and, after the pressure has been released completely, is cooled. The method according to the invention is generally an extrusion method.

The foaming agents to be used are selected from the group consisting of physical foaming agents and chemical foaming agents.

Throughout the description the term foaming agent is used; it should be noted that in this field also the term blowing agent is used. In this invention these terms have the same meaning and can both be used to describe the agent which brings about the foaming phenomenon.

Examples to be mentioned of physical foaming agents include carbon dioxide, nitrogen, air, oxygen, noble gases, water and isoalkanes such as isopentane.

Chemical foaming agents can also be used, examples of which to be mentioned being sodium bicarbonate and azodicarbonamide and mixtures with other additives comprising these.

In a first advantageous embodiment of the method according to the invention, in the case of polypropylene being processed, the foaming agent used is nitrogen, employed in an amount of at most about 0.12%, based on the weight of the thermoplastic, and preferably in an amount of from 0.05 to 0.10%, based on the weight of the thermoplastic.

Above value of 0,12 wt % of N₂ can be calculated as follows:

From experiments it is known that in practice the PP foam density, for a uniform foam having a closed-cell structure, will be approximately 0,5 of the unfoamed polypropylene. The foam density is related to the weight fraction of gas as follows:

$$\frac{1}{ρ foam} = \frac{x}{ρ gas} + \frac{1 - x}{ρ pp}$$

wherein ρ is the density in kg/m³.

For a relative density ρ foam/ρ pp =0,5

this relation is

$$\frac{1}{0 , 5 ρ pp} = \frac{x}{ρ gas} + \frac{1 - x}{ρ pp}$$

$$x = \frac{1}{ρ pp / ρ gas - 1} \approx \frac{ρ gas}{ρ pp} = \frac{1 , 14}{900} = 0 , 00126$$

The weight amount is therefore 0,00126×100=0,126 wt %.

Experiments have confirmed that for nitrogen at a foam-cell diameter of about 50 micrometres, a close-packed structure as defined above requires an amount of gas of at most about 0.12%.

The amount of 0.12 wt % is the preferred maximum amount to be used if nitrogen is employed as foaming agent.

If the foaming agent is carbon dioxide, this is used, in processing polypropylene, in an amount of at most about 0.19%, based on the weight of thermoplastic, and preferably an amount of from 0.10 to 0.15%, based on the weight of the thermoplastic.

The amount of carbon dioxide required to form a close-packed structure having a uniform foam-cell diameter of 50 microns in polypropylene is found to be at most about 0.19%, and in practice the value of 0.19% should not be significantly exceeded if a microfoam-containing article having a uniform foam-cell diameter is to be obtained.

The above-listed amounts of foaming agent which are theoretically required to achieve a close-packed structure of closed cells are valid for polypropylene having a density of about 0.91 g/cm³. If the plastic is poly(vinyl chloride) (density about 1.4), the theoretical maximum amount of foaming agent is about 0.08 wt % for nitrogen and 0.12 wt % for carbon dioxide. Again it is the case that the actually employed amounts should preferably substantially agree with the theoretical amounts of foaming agent; minor deviations can be tolerated, but will lead to less good result. For PP and nitrogen, an amount of 0.18 wt % of nitrogen instead of the theoretical 0.12 wt % will afford a product which is still acceptable, but which is of lower quality compared with the theoretically optimal product.

The amounts employed in the above-discussed prior art of at least 2 wt % are therefore considerably above the amounts of foaming agent employed in the method according to the invention.

Extensive research has shown the importance of the pressure drop rate for the melt upon leaving the extruder die. In order to assure that foaming starts only after the melt has left the extruder-head and to obtain a good foam i.e. a foam having a uniform cell structure and dimensions in the range of, say, 20-100 μm, a minimum pressure-drop rate has to be observed. The minimum pressure dop rate is expressed by the following formula:

$$\frac{ⅆ P}{ⅆ t} > \frac{β \cdot {R}_{o} \cdot {C}_{ba}^{2}}{η {H}^{2}}$$

Wherein:

β is a proportionality factor,

Rₒ is the critical cell radius in m,

C_{ba} is the concentration of blowing agent in g/cm³,

η is the viscosity of the melt in Pa.s,

H is Henri's constant,

$$\frac{ⅆ P}{ⅆ t}$$

is expressed in

$$\frac{Pa}{sec} .$$

In above formula Henri's constant is related to the solubility of the blowing agent, such as nitrogen or carbon-dioxyde, in the thermoplastic resin used.

The relation thereof is:

C_{ba}=H.P.

Some values of H are:

| Blowing agent | Resin | H cm³/g · atm |
|---|---|---|
| N₂ | PP | 0.133 |
| N₂ | PE | 0.111 |
| CO₂ | PP | 0.275. |

In the formula C_{ba} (concentration blowing agent) is expressed as the amount of gas, in cm³ at 23° and 1 atm, which can be dissolved in 1 gram of polymer at a certain pressure P of the melt.

The viscosity η decreases when increasing the temperature; as η in above formula for dP/dt is included in the denominator a higher temperature of the melt necessitates a higher pressure drop rate as will be illustrated hereinafter. Rₒ in above formula is the critical cell radius of the gas cells. When the radius of a cell is higher than Rₒ, the cells will grow in size; when the radius is smaller than Rₒ, the cells will collapse.

When preparing polypropylene foam with nitrogen as blowing agent having a density oa approx. 60% of the solid resin and a N₂ dosage of 0.05 wt % at a temperature of 180-185° C. a pressure drop rate dP/dt≧10 MPa/sec. is used at the same values for all parameters except the viscosity; in any case dP/dt<50 MPa/sec.

When a working condition is chosen wherein the pressure drop rate is lower than indicated above a non-uniform foam structure will be obtained having a large proportion of ruptured cells. The mechanical properties of such a foam have deteriorated in comparison to a foam having a uniform foam structure; the product obtained shows an uneven surface structure.

In a preferred embodiment of the above-described method according to the invention, the method is an extrusion method wherein at least one stream of thermoplastic is forced under pressure through an orifice, which gives the object to be formed its shape, and is then cooled, and wherein at least one stream comprises a foaming agent. The extrusion method can be a method wherein one stream of thermoplastic is formed into an article; alternatively, the method can be a coextrusion method, where two or more streams of thermoplastic are formed by the extrusion die into an article which comprises a plurality of layers and/or interconnected parts and of which then at least one layer or part is foamed.

In the above-described prior art WO 98/08667, the stream of thermoplastic, which incorporates a foaming agent such as a gas, is subjected to a nucleation which, for example, may comprise subdividing the stream of thermoplastic into a plurality of substreams, subjecting each of the substreams to a pressure drop, and recombining the substreams.

The abovementioned extrusion method can likewise comprise nucleation of this type.

Reference is also made in this context to the applicant's Dutch patent application 1010057, unpublished at the priority date of the present invention, which describes a method and apparatus for extruding foamed products such as pipes.

The said application describes a method for extruding foamed articles made of thermoplastic, which involves forcing a melt consisting of heated, pressurized plastic mixed with a foaming agent, being forced through a nucleator and an orifice shaping the article and is then cooled, said method being wherein the melt is first forced through the shaping orifice and then through the nucleator. The nucleator in the said application comprises a multiplicity of fine ducts which preferably are in the form of a plurality of sieves having a mesh size of from 50 to 500 micrometres, preferably from 100 to 300 micrometres. The type of nucleator as described above serves to alter the thermodynamic equilibrium of the plastic/foaming agent mixture, thus promoting the process of the gas coming out of solution.

Expediently, in the method according to the invention, the thermoplastic contains a particulate nucleating filler which, as the name indicates, owing to the presence of fine particles induces the formation of nuclei for foam cells which will develop subsequently. To make the following easier to read, the term nucleating agent will frequently be used hereinafter instead of the term particulate nucleating filler.

Preferably, a nucleating agent is used which has an aspect ratio of between 5 and 100. The aspect ratio of a particle is the ratio of the largest to the smallest dimension of the particle, and it was found that good results, in particular, are achieved using fillers of platelet structure, which leads to the said relatively high aspect ratio. Agents suitable as nucleating agents include mica, kaolin, talc, graphite, aluminium trihydrate etc.

Fillers of other shapes, such as spherical, cubical, rectangular and wire-like, which are widely available, for example, at aspect ratios in the range of from 1.4 to 4 do have some effect, but are less satisfactory than the agents having an aspect ratio range of from 5 to 100.

Examples of agents having an aspect ratio of between 1.4 and 4 include silicon dioxide and barium sulphate.

Agents having a high aspect ratio as specified can also include pigments such as titanium dioxide and flame retardants such as antimony oxide.

Another important factor in the context of the invention is that the nucleating agents should preferably have a relatively large particle size for optimum effect.

Talc of the type Luzenac® 1445 (mean particle size d50:10 micrometres, d95:29 micrometres) affords a more regular foam having a smaller cell diameter than Luzenac® 10 MOOS (d50:3.7 micrometres; d95:9.3 micrometres).

A fine chalk of particle size of about 1 micrometre is virtually ineffective, surprisingly.

Generally it can be said of the nucleating agent to be used that it preferably has a mean particle size>3 μm and more preferably >10 μm . Talc meeting these requirements proved effective.

When nucleating agents are used, an increase in the number of foam cells is observed which is generally proportional to the number of particles.

In this context, reference can be made, for example, to Lewis K. Cheung and Chul B. Park, American Society of Mechanical Engineers, 1996, 76 (Cellular and Microcellular Materials, pp. 81-103), where the effect of fillers such as talc on the cell density of extruded polypropylene foams is discussed and which says that the use of talc in concentrations greater than 5 wt %, based on the mixture as a whole, does not make sense, since the abovementioned concentration of the cell density, i.e. the number of cells per unit volume, shows no significant further increase; this result applies to both foaming gases studied in the said article, viz. CO₂ and isopentane.

The abovementioned article also reports an increase in the number of open cells when high concentrations of talc are employed; in the invention this is obviously undesirable.

The said article employs gas concentrations of between 1 and 6 wt %, whereas in the present invention use is made, in connection with the desired close-packed structure, of concentrations which, for example for nitrogen, are limited to at most about 0.12%, based on the weight of thermoplastic, and for CO₂ to at most about 0.19% if polypropylene is being processed. If the said lower gas concentrations leading to a close-packed structure are adhered to, a pronounced effect is observed, surprisingly, of an increase in the filler concentration, it being the case, in particular, that if talc of mean particle size>3 μm and preferably >10 μm is used, that the following values are obtained when preparing a polypropylene foam.

| | Mean foam-cell diameter in |
|---|---|
| Wt % of filler | micrometres |
| 2.5 | 300-500 |
| 5 | 150-250 |
| 10 | 80-120 |
| 20 | 40-60 |
| 40 | 20-30 |

It can be seen that as the concentration of filler increases an approximately linear decrease of the foam-cell diameter is observed, said foam-cell diameter being substantially uniform throughout the foam.

This therefore means that the number of foam cells formed increases disproportionately with the concentration of nucleating agent.

The abovementioned article by Cheung et al. suggests that the use of more than 5% of talc is pointless; in the present invention it was found that, given an adequately low gas concentration, there is a striking effect on the foam-cell diameter and that consequently there are advantages even employing high filler concentrations. An increase in the number of open cells, as recorded by Cheung et al., is not found, presumably as a result of the small amount of foaming agent employed according to the invention.

Above relation between filler loading and cell diameter was also investigated for polyvinylchloride. When no nucleating agent such as talc is added a coarse foam structure is formed having cells of 0,5 -2 mm diameter. Addition of 5 wt % preferably 3% talc results in a homogeneous all structure having cells of approximately 50 μm. Increasing het loading of talc to 10, 20 or 30 wt % has no substantiall influence on the cell diameter which remains approximately 20-50 μm.

Generally, the product will have to meet certain impact resistance requirements, and in the invention it proved advantageous for the thermoplastic to be mixed with an impact modifier.

Such an impact modifier can be selected from polymeric modifiers such as LDPE (Low Density Polyethylene), ABS (Acrylonitrile Butadiene Styrene), MBS (Methacrylonitrile Butadiene Styrene), EVA (Ethylene Vinyl Acetate), chlorinated PE, low-crystallinity PP copolymers (e.g. Adflex® 100QF) and the like, or mixtures thereof, and the modifier or mixture of modifiers is used in a concentration of from 2 to 40%, based on the weight of the thermoplastic, and preferably 5-15%.

Foaming is also promoted by the thermoplastic being admixed with a surface-active agent.

Surface-active agents are generally known and are selected from surface-active agents which are compatible both with the thermoplastic and the nucleating agent, examples of these being: fatty alcohols, esters based on dicarboxylic acids and natural short-chain fats/alcohols, esters of alcohols and of long-chain fatty acids and the like or mixtures thereof, a surface-active agent or mixture of this type being used in a concentration of from 0.1 to 5% based on the weight of the thermoplastic. A suitable surface-active agent is glycerol monostearate (GMS).

In particular, the surface-active agent is employed in a concentration of from 0.3 to 3 wt % of the weight of the thermoplastic, and preferably in a concentration of from 0.5 to 2 wt %.

The method according to the invention can be used for fabricating a variety of articles such as panels, blocks, enclosures and the like; highly advantageously, the method according to the invention as described hereinabove is used to form a pipe, two embodiments in particular being worth mentioning.

In the first instance, the invention relates to a method of the above-described type, in which the article formed is a pipe in which the inner and/or outer walls have a foam-cell diameter considerably smaller than 10 micrometres and in which preferably no foam cells are present or only in the rudimentary foam. Those parts of the pipe which are situated further inwards then have the uniform microfoam character aimed for according to the invention, with a very small foam-cell diameter, the foam-cell diameter generally having a uniform value.

The presence of very small foam cells (or even the absence of foam cells) in the surface of inner and outer wall of the pipe may be the result of the small amount of gas rapidly diffusing away from a thin surface layer while the formed pipe is cooling down.

In another embodiment of the method according to the invention, the formed article is a pipe, wherein to form a completely tight inner and outer wall of the pipe, the method is implemented as a coextrusion method and the stream of thermoplastic for the inner and outer wall is supplied free from foaming agent, while the foam-cell diameter in the foam-comprising section of the pipe is uniform and is set, as a function of the desired dimensions, to a predetermined value by the choice of the concentration of suitable nucleating agent.

For the inner and outer walls and the foam comprising section (the core) all types of conventional thermoplastic resins can be used such as polypropylene, polyethylene, polyvinylchloride, polystyrene, ABS can be used.

Surprising good results were obtained when recycled polyvinylchloride was used. Although such material may contain a large proportion of solid impurities having particle sizes of 0,5 -1 mm a homogeneous microfoam is obtainable having a cell diameter between 20 and 50 μm.

The invention will now be described with reference to a number of examples.

| Material | Type | Composition in wt % | | | | | | |
|---|---|---|---|---|---|---|---|---|
| PP | HMA6100 | | | 80 | 70 | 90 | | |
| P | HY600 | 90 | 80 | | | | | |
| PP | Borealis | | | | | | 90 | 86 |
| | CEC 4412 | | | | | | | |
| | Adflex Q100F | | | | | 5 | | |
| | LDPE | | 10 | | | | | |
| Talc | Luzenac 1445 | | 10 | 20 | 30 | 5 | 10 | 10 |
| Chalk | Durcal 15 | 10 | | | | | | |
| | Nitrogen | 0.07 | 0.07 | 0.07 | 0.07 | 0.07 | 0.07 | 0.035 |
| GMS | | | | | | | | 1 |
| | Mastertec ® | | | | | | | 3 |
| | Density | 0.62 | 0.59 | 0.65 | 0.74 | 0.56 | 0.58 | 0.59 |
| | (g/cm³) | | | | | | | |
| | Young's | 580 | 400 | 650 | 720 | 370 | 470 | 500 |
| | modulus | | | | | | | |
| | (MPa) | | | | | | | |
| | Cell diam. | 100/200 | 50/100 | 25/75 | 20/50 | 100/200 | 50/100 | 50/100 |
| | (μm) | | | | | | | |

The percentages are based on the total of the mixture. HY 6100 is a PP homopolymer, HMA 6100 and Borealis CEC 4412 are PP copolymers. Mastertec is a masterbatch of PP with combined pigment and flame retardant. It was found that if that composition was used in conjunction with foam forming according to the invention, the pipe in flammability tests gave a better flame tetardancy comparable to that observed in unfoamed pipes containing 1.5 times more flame retardant.

Yet a further improvement of the impact resistance of pipes according to the last example is obtained by the addition of 6 wt % of Adflex® 100QF (a flexible low modulus PP copolymer). This does result in a somewhat reduced Young's modulus.

Generally when extruding polypropylene a single extruder is used whereby a well defined uniform foam is obtained. For large diameters with thick walls high resin throughputs are necessary and expediently a dual-extruder concept is used in such case. In a first extruder polymer is molten, gas is injected in the melt and dissolved therein. The pressure in the extruder should be sufficiently high to ensure that the gas remains dissolved in the melt. The mixture of molten polymer and gas is fed to a second extruder wherein a further homogenizing of the gas is achieved and wherein the temperature of the mixture is decreased. The viscosity of the melt is thereby increased and an improvement in mechanical properties such as impact strength and E-modulus are observed.

In the second extruder, by choice of a suitable die head, the pressure is kept at the required high level. This also applies when using a chemical blowing agent.

This is illustrated by the following table whereby the increased viscosity shows itself by an increased pressure of the melt:

| | Impact strength | | |
|---|---|---|---|
| | (H-50 value in | | |
| Pressure (bar) | m) | E-modulus (MPa) | Viscosity |
| 81.5 | 0.96 | 430 | low |
| 83 | | 428 | ▴ |
| 84 | 1.07 | 485 | \| |
| 85 | | 495 | \| |
| 87 | 1.23 | | \| |
| 91.5 | | 580 | ▾ |
| 93 | 1.48 | 570 | high |

Of course the possibilities for lowering the temperature are limited by the point of solidification of the thermoplastic concerned, in particular crystalline and partial crystalline thermoplastics such as PP and PE. For amorphous thermoplastics like PVC and PS and ABS this lower temperature does not apply. The limit is there governed by a Strong increase in viscosity necessitating an extruder power which exceeds the power normally available.

As stated above, polypropylene may be mentioned as a suitable thermoplastic; other thermoplastics such as polyethylene, poly(vinyl)chloride, polystyrene, ABS etc. can ewise be used.

What is claimed is:

1. Method for forming an article comprising closed-cell microfoam from thermoplastic, wherein at least one molten thermoplastic comprising a foaming agent is subjected under pressure to a forming operation and, after the pressure has been released, is cooled, wherein the amount of foaming agent is substantially identical to the amount corresponding to that quantity of gas incorporated in the foaming agent which is comprised by a close-packed structure of the foam cells having a foam-cell diameter, which is substantially uniform throughout the foam.

2. Method according to claim 1, wherein the foaming agent is selected from the group consisting of physical foaming agents and chemical foaming agents.

3. Method according to claim 2, wherein the foaming agent is a physical foaming agent selected from the group consisting of carbon dioxide, nitrogen, air, oxygen, noble gases, water and isoalkanes such as isopentane.

4. Method according to claim 2, wherein the foaming agent is a chemical foaming agent such as sodium bicarbonate and azodicarbonamid and mixtures with other additives comprising these.

5. Method according to claim 3, wherein the foaming agent is nitrogen and is used in the processing of polypropylene in an amount of about 0.12% based on the weight of the thermoplastic.

6. Method according to claim 3, wherein the foaming agent is carbon dioxide and is used in the processing of polypropylene in an amount of about 0.19% based on the weight of the thermoplastic.

7. Method according to claim 1 wherein the pressure drop rate dP/dt is controlled according to the following equation:
$$\frac{ⅆ P}{ⅆ t} > \frac{β \cdot {R}_{o} \cdot {C}_{ba}^{2}}{η {H}^{2}}$$
wherein:
β is a proportionality factor,
Rₒ is the critical cell radius in m,
C_{ba} is the concentration of blowing agent in g/cm³,
η is the viscosity of the melt in Pa.s,
H is Henri's constant,
$$\frac{ⅆ P}{ⅆ t}$$
is expressed in
$$\frac{Pa}{sec} .$$

8. Method according to claim 7 wherein for preparing a polypropylene foam dP/dt at 180° C.-190° C. is set at ≧20 MPa/sec. and at 170-175° C. at ≧10 MPa/sec, in any case however dP/dt ≦50 MPa/sec.

9. Method according to claim 1, wherein the method is an extrusion method wherein at least one stream of thermoplastic is forced under pressure through an orifice, which gives the object to be formed its shape, and is then cooled, and wherein at least one stream comprises a foaming agent.

10. Method according to claim 1, wherein a nucleation agent is present in the thermoplastic.

11. Method according to claim 10, wherein a nucleating agent having an aspect ratio of between 5 and 100 is used.

12. Method according to claim 10, wherein the nucleating agent used is talc having a mean particle size of >3 micrometres and preferably >10 micrometres.

13. Method according to claim 10, wherein the concentration of nucleating agent is chosen in conjunction with the desired mean foam-cell diameter.

14. Method according to claim 12, wherein the nucleating agent used is talc in amounts suitable for the foam-cell diameter of polypropylene to be formed as follows:

| | Mean foam-cell diameter in |
|---|---|
| Wt % of filler | micrometres |
| 2.5 | 300-500 |
| 5 | 150-250 |
| 10 | 80-120 |
| 20 | 40-60 |
| 40 | 20-30 |

15. Method according to claim 12 for forming a polyvinylchloride foam wherein 3 up to 5 or more weight % of talc is used to obtain a foam having a mean foam cell diameter of about 50 μm.

16. Method according to claim 1, wherein the thermoplastic is admixed with an agent which improves the impact resistance of the plastic (an impact modifier).

17. Method according to claim 16, wherein the plastic is polypropylene and the impact modifier is selected from the group of polymeric modifiers such as low-crystallinity PP, LDPE, ABS, MBS, EVA, chlorinated PE and the like or mixtures thereof, and the agent or mixture of agents is used in a concentration of 2-40%, based on the weight of the thermoplastic, and preferably of 5-15%.

18. Method according to one or more of the preceding claims, wherein the thermoplastic is admixed with a surface-active agent.

19. Method according to claim 18, wherein the surface-active agent is selected from the group consisting of fatty alcohols, esters based on dicarboxylic acids and natural short-chain fats/alcohols, esters of alcohols and long-chain fatty acids and the like or mixtures thereof, and the agent is used in a concentration of 0.1 -5% based on the weight of the thermoplastic.

20. Method according to claim 19, wherein the surface-active agent is used in a concentration of 0.3-3 wt %, preferably in a concentration of 0.5-2%.

21. Method according to claim 9, wherein the formed article is a pipe whose inner and/or outer walls have a foam-cell diameter of less than 10 micrometres.

22. Method according to claim 9, wherein the formed article is a pipe and, to form a completely tight inner and outer wall of the pipe, the method is implemented as a coextrusion method and the stream of thermoplastic for the inner and outer wall is supplied free from gas, whereas gas and nucleation agent are fed into the stream for the part between the inner and outer walls to adjust the foam-cell diameter therein to a predetermined value by choosing the concentration of nucleation agent.

23. Method for forming an article comprising closed-cell microfoam from thermoplastic, wherein at least one molten thermoplastic comprising a foaming agent is subjected under pressure to a forming operation and, after the pressure has been released, is cooled, wherein the amount of foaming agent is at most identical to the amount corresponding to that quantity of gas incorporated in the foaming agent which is comprised by a close-packed structure of the foam cells having a foam-cell diameter, which is substantially uniform throughout the foam.

24. Method according to claim 23, wherein the foaming agent is selected from the group consisting of physical foaming agents and chemical foaming agents.

25. Method according to claim 24, wherein the foaming agent is a physical foaming agent selected from the group consisting of carbon dioxide, nitrogen, air, oxygen, noble gases, water and isoalkanes such as isopentane.

26. Method according to claim 25, wherein the foaming agent is a chemical foaming agent such as sodium bicarbonate and azodicarbonamid and mixtures with other additives comprising these.

27. Method according to claim 25, wherein the foaming agent is nitrogen and is used in the processing of polypropylene in an amount of about 0.12% based on the weight of the thermoplastic.

28. Method according to claim 27, wherein an amount of 0,05 0,10 wt. % based on the weight of the thermoplastic is used.

29. Method according to claim 25, wherein the foaming agent is carbon dioxide and is used in the processing of polypropylene in an amount of about 0.19% based on the weight of the thermoplastic.

30. Method according to claim 29, wherein an amount of 0,10-0,15 wt. % based on the weight of thermoplastic is used.

31. Method according to any of the claims 23-30, wherein said method includes the aspects as given in any of the claims 7-22.
